(19) United States
(12) Patent Application Publication
(10) Pub. No.: US 2026/0094954 A1
(43) Pub. Date: Apr. 2, 2026

(54) Battery Case, Battery Assembly, and Battery Pack

(71) Applicant: SK On Co., Ltd., Seoul (KR)

(72) Inventor: Sun Ho JANG, Daejeon (KR)

(21) Appl. No.: 19/294,374

(22) Filed: Aug. 8, 2025

(30) Foreign Application Priority Data
Sep. 27, 2024 (KR) 10-2024-0131761

(51) Int. Cl. H01M 50/578; H01M 50/204; H01M 50/296; H01M 50/317; H01M 50/367; H01M 50/503

(52) U.S. Cl. CPC H01M 50/578; H01M 50/204; H01M 50/296; H01M 50/317; H01M 50/367; H01M 50/503; H01M 2200/20

(57) ABSTRACT

A battery case according to embodiments of the present disclosure includes a case body including a receiving space in which a battery cell is arranged, and a connector formed on one surface of the case body and electrically connecting the battery cell arranged therein to an external device, wherein the connector is configured to be electrically disconnected from the battery cell when the internal pressure of the case body increases.

### CROSS-REFERENCE TO RELATED PATENT APPLICATION

The present application claims priority under 35 U.S.C. § 119(a) to Korean patent application number 10-2024-0131761 filed on Sep. 27, 2024 in the Korean Intellectual Property Office, the entire disclosed portion of which is incorporated by reference herein.

### BACKGROUND OF THE INVENTION

### 1. Field

The present disclosure relates to a battery case, a battery assembly, and a battery pack, and more particularly, to a battery case, a battery assembly, and a battery pack having excellent reliability.

### 2. Description of the Related Art

Secondary batteries convert electrical energy into chemical energy and store the chemical energy so that the secondary batteries can be reused multiple times through charging and discharging. Secondary batteries are widely used throughout the industry due to their economical and eco-friendly characteristics.

Secondary batteries can be classified as battery cells, battery assemblies (e.g., battery modules, battery packs, etc.), or the like, based on units thereof.

A battery assembly may include a plurality of battery cells. When high-temperature gas or dust is generated from battery cells in the battery assembly, the gas or the dust may affect neighboring battery cells and accelerate heat propagation, thereby degrading stability. Accordingly, there is a need for a technology capable of improving stability.

### SUMMARY OF THE INVENTION

An aspect of the present disclosure is to provide a battery assembly with improved stability.

An aspect of the present disclosure is to provide a battery assembly having excellent stability in the event of a fire.

An aspect of the present disclosure is to provide a battery module or a battery pack with excellent reliability.

Meanwhile, a battery assembly according to the present disclosure may be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions

A battery case according to embodiments of the present disclosure may include a case body including a receiving space in which a battery cell is arranged, and a connector formed on one surface of the case body and electrically connecting the battery cell arranged therein to an external device, wherein the connector is configured to be electrically disconnected from the battery cell when the internal pressure of the case body increases.

The connector may be moved in an outward direction to be electrically disconnected from the battery cell arranged therein when the internal pressure of the case body increases.

The battery case may further include a venting path formed in the case body, discharging gases generated in the case body to an outside, and opened and closed by the connector.

The venting path may include vertical and horizontal flow paths, and the horizontal flow path may be opened and closed by the connector.

The connector may include: a main connector electrically connected to an external device, and one or more sub-connectors connecting the main connector to the battery cell arranged therein.

The main connector or one sub-connector of the one or more sub-connectors may be moved in an outward direction to be electrically disconnected from the battery cell arranged therein when the internal pressure of the case body increases.

The connector may include: a main connector electrically connected to an external device; a first sub-connector arranged at a lower portion of the main connector, and a second sub-connector arranged at a lower portion of the first sub-connector and electrically connected to the battery cell arranged therein, wherein the first sub-connector is moved in an outward direction to be electrically disconnected from the battery cell when the internal pressure of the case body increases.

The main connector and the one sub-connector may be formed at a predetermined distance.

The connector may include an insulating portion and a conductive portion and the conductive portion may be a conductive terminal pin.

The connector may include a conductive terminal pin, and the conductive terminal pin may rise in the outward direction to electrically disconnect the conductive terminal pin from the battery cell as the internal pressure of the case body increases.

The connector may include: a conductive terminal pin, wherein one end of the conductive terminal pin is connected to an external device and an other end thereof is electrically connected to the battery cell arranged therein, the conductive terminal pin including a barrel portion including a hollow portion, and a plunger or a contact pin whose portion is inserted into the barrel portion, and wherein the plunger or the contact pin is inserted into the barrel portion to electrically disconnect the conductive terminal pin from the battery cell when the internal pressure of the case body increases.

A plunger of a conductive terminal pin may be formed on the main connector, a barrel portion of the conductive terminal pin may be formed on the first sub-connector, and a contact pin of a conductive terminal pin may be formed on the second sub-connector.

A battery assembly according to embodiments of the present disclosure may include a case body including a receiving space therein, one or more battery cells arranged in the receiving space, and a connector formed on one surface of the case body and electrically connecting the one or more battery cells and an external device, wherein the connector is configured to be electrically disconnected from the one or more battery cells when the internal pressure of the case body increases.

The battery assembly may further include a connection frame electrically connecting the one or more battery cells, wherein the connection frame is electrically connected to the connector.

The battery assembly may be a battery module.

A battery pack according to embodiments of the present disclosure may include at least one battery module according to embodiments of the present disclosure.

### BRIEF DESCRIPTION OF THE DRAWINGS

FIG. 1 is a perspective view schematically illustrating a battery assembly according to one embodiment.

FIG. 2 is an exploded perspective view schematically illustrating a battery assembly according to one embodiment.

FIG. 3 is a diagram schematically illustrating a portion of a battery assembly according to one embodiment.

FIGS. 4 and 5 are diagrams illustrating the operation of a connector according to one embodiment.

FIG. 6 is a perspective view schematically illustrating a structure of a connector according to one embodiment.

FIG. 7 is a diagram illustrating a structure in which a conductive terminal pin is formed in a connector according to one embodiment.

FIG. 8 is a perspective view schematically illustrating a conductive terminal pin according to one embodiment.

FIGS. 9A, 9B and 9C are diagrams schematically illustrating a process by which a conductive terminal pin is disconnected according to one embodiment.

FIGS. 10 and 11 are drawings illustrating the operation of a connector and a conductive terminal pin according to one embodiment of the present disclosure.

### DETAILED DESCRIPTION

Hereinafter, the present disclosure will be described in detail with reference to the accompanying drawings. This is, however, illustrative only and not intended to limit the disclosed portion to the specific embodiments illustratively described.

Specific structural or functional descriptions of examples of embodiments in accordance with concepts which are disclosed in this specification are illustrated only to describe the examples of embodiments in accordance with the concepts and the examples of embodiments in accordance with the concepts may be carried out by various forms but the descriptions are not limited to the examples of embodiments described in this specification.

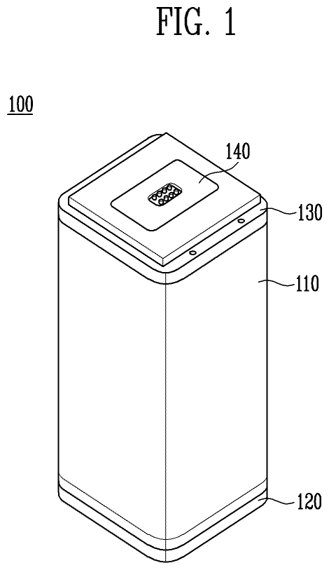

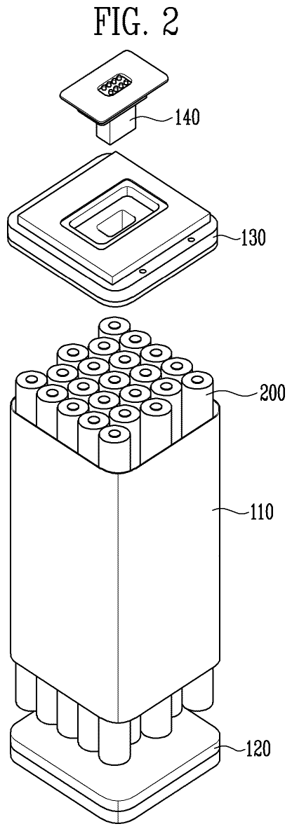

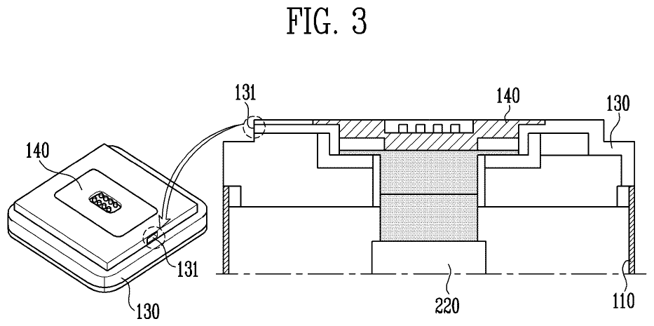

FIG. 1 is a perspective view schematically illustrating a battery assembly 100 according to one embodiment, FIG. 2 is an exploded perspective view schematically illustrating the battery assembly 100 according to one embodiment, and FIG. 3 is a diagram schematically illustrating a portion of the battery assembly 100 according to one embodiment.

One embodiment of the present disclosure is directed to a battery case which receives battery cells 200, and another embodiment of the present disclosure is directed to the battery assembly 100 having the battery cells 200 received in the battery case.

Referring to FIGS. 1 to 3, a battery case according to one embodiment of the present disclosure may include a case body (110, 120, and 130) having a receiving space within which the battery cells 200 are disposed, and a connector 140 formed on one surface of the case body (110, 120, and 130).

The battery cells 200 are received in the battery case, which may be understood as the battery assembly 100. Hereinafter, the battery case and the battery assembly 100 will be described together.

In one embodiment, the battery cell 200 may be a secondary battery capable of being charged and discharged a plurality of times. Examples of the secondary battery may be, but is not limited to, a lithium cobalt battery, a lithium high nickel battery, a lithium iron phosphate battery, a lithium ion battery, a lithium polymer battery, a lithium sulfur battery, a nickel hydrogen battery, a nickel cadmium battery, a sodium battery, an all-solid-state battery, and the like.

In one embodiment, the battery cell 200 may have a cylindrical shape. The present disclosure is not limited thereto, and the battery cell may be a pouch type battery cell, a prismatic battery cell, or the like depending on the packaging type.

In one embodiment, the battery assembly may be a battery module including one or more battery cells. Alternatively, in one embodiment, the battery assembly may be various types of devices such as a battery pack or an energy storage system (ESS), but the present disclosure is not limited thereto.

The battery case according to one embodiment of the present disclosure may include the case body (110, 120, and 130), and the connector 140 formed on one surface of the case body. The connector 140 may electrically connect a battery cell arranged in the case body to an external device, and the connector 140 may configured to be electrically disconnected from the battery cell arranged therein when the internal pressure of the case body increases.

In one embodiment, the case body (110, 120, and 130) may have an opening for receiving battery cells, and after receiving the battery cells through the opening, the opening may be closed with a cover member.

In one embodiment, the case body (110, 120, and 130) may be of various shapes having a receiving space therein, and the case body may have a cylindrical shape, an angular shape, and the like, but the present disclosure is not limited thereto.

As shown in FIG. 2, in one embodiment, the case body may include a main body 110 which is open at both ends and formed by side portions, a first cover 130 which covers one end of the main body 110, and a second cover 120 which closes the other end of the main body 110.

However, the present disclosure is not limited thereto, and the main body 110 and the second cover 120 may be formed integrally. In one embodiment, the second cover 120 and the side portions may be a unitary container shape (U). Alternatively, the main body 110 and the first cover 130 may be formed integrally. When the main body 110 and the second cover 120 or the first cover 130 are formed integrally, a through hole with a predetermined size may be formed on one surface of the case body, and the connector 140 may be disposed in the through hole.

The present disclosure is not limited thereto, and the main body 110, the second cover 120, and the first cover 130 may be joined together by bolting, welding, or the like after receiving the battery cells 200.

As shown in FIG. 2, in one embodiment, the connector 140 may be installed on the first cover 130. However, the present disclosure is not limited thereto, and the connector 140 may be formed on the second cover 120 or on the side portions.

In one embodiment, the connector 140 may be disposed in the through hole with the predetermined size formed in the first cover 130, and may communicate with an internal receiving space of the case body. The internal receiving space and the outer space of the case body may be connected by the connector 140.

The battery assembly 100 may be electrically connected to an external device by the connector 140. That is, the battery cells 200 may be charged and discharged by the connector 140.

In one embodiment, a venting path 131 may be formed in the case body.

Referring to FIG. 3, the venting path 131 may be formed in the first cover 130, and may be opened and closed by the connector 140. The venting path 131 forms a path for discharging gases generated within the case body to the outside.

In one embodiment, the venting path 131 may be formed on one surface of the case body in which the connector 140 is formed, an inlet of the venting path 131 may be formed on an inner surface of the case body, and an outlet of the venting path 131 may be formed on an outer surface of the case body. The inner surface of the case body may be defined as a surface abutting the inner receiving space of the case body, and the outer surface of the case body may be defined as a surface abutting an outer space of the case body.

In one embodiment, the venting path 131 may be opened and closed by movement of the connector 140.

In a normal operating state of the battery assembly, the case body remains sealed. However, when the internal pressure of the case body rises due to gas generated by the battery cell 200, the connector 140 may be moved in an outward direction, thereby opening the venting path 131. When the venting path 131 is opened, the internal gas may be discharged to the outside. This will be described below.

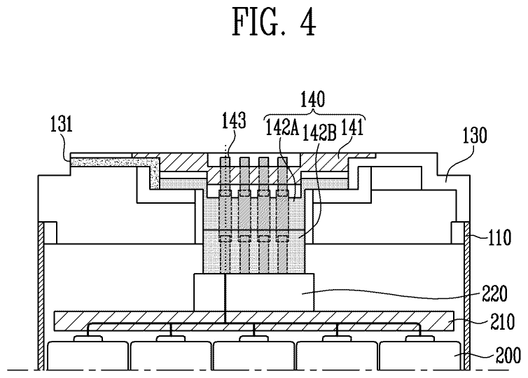

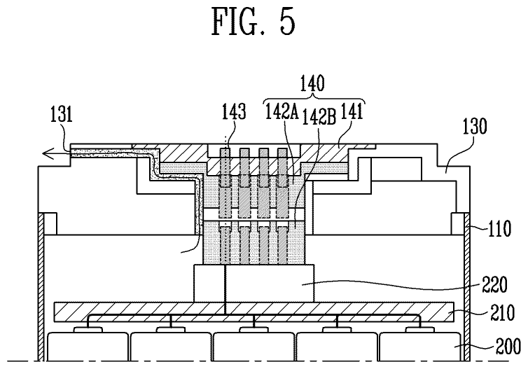

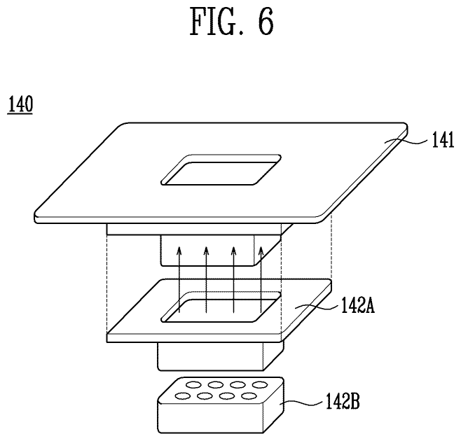

FIGS. 4 and 5 are diagrams illustrating the operation of the connector 140 according to one embodiment. FIG. 4 is a diagram schematically illustrating a state in which the connector 140 and the battery cell 200 are electrically connected, and FIG. 5 is a diagram schematically illustrating a state in which the connector 140 and the battery cell 200 are electrically disconnected. FIG. 6 is a perspective view schematically illustrating the structure of the connector 140 according to one embodiment.

In one embodiment, one end of the connector 140 may be electrically connected to an external device, and the other end of the connector 140 may be electrically connected to the battery cells 200.

When the internal pressure of the case body rises during the operation of the battery assembly, the internal pressure may cause the connector 140 to move in the outward direction, and the movement of the connector 140 may cause the connector 140 and the battery cell 200 to be electrically disconnected from each other.

In one embodiment, the connector 140 may include a main connector 141 which is electrically connected to an external device, and one or more sub-connectors 142A and 142B which connect the main connector 141 to the battery cells 200 arranged therein.

In one embodiment, the main body connector 141 or one of the one or more sub-connectors 142A and 142B may move outwardly to electrically disconnect from the battery cell 200 arranged therein when internal pressure of the case body increases.

Referring to FIGS. 4 to 6, in one embodiment, the battery cell 200 may include the main connector 141 electrically connected to an external device, a first sub-connector 142A disposed at a lower portion of the main connector, and a second sub-connector 142B disposed at a lower portion of the first sub-connector and electrically connected to the battery cell 200. Between the main connector 141 and the first sub-connector 142A, a distance may be formed over which the first sub-connector 142A is movable. That is, the main connector and the sub-connector may be formed with a predetermined spacing.

When the internal pressure of the case body rises, the internal pressure may cause the first sub-connector 142A to rise, thereby releasing the electrical connection between the first sub-connector 142A and the second sub-connector 142B. Further, the electrical connection between the main connector 141 and the battery cell 200 may be released thereby. Even when the main connector 141 is electrically connected to the external device and the second sub-connector 142B is electrically connected to the battery cell 200, the electrical connection between the external device and the battery cell 200 may be released by the movement of the first sub-connector 142A, thereby blocking the flow of current.

According to one embodiment, the main connector 141 and the first sub-connector 142A may be formed with a predetermined spacing. Further, a protrusion may be formed on a lower portion of the main connector 141, and a receiving portion receiving the protrusion may be formed on the first sub-connector 142A disposed on the lower portion of the main connector 141. When the first sub-connector 142A is raised in the outward direction, the protrusion of the main connector may be received in the receiving portion of the first sub-connector 142A.

According to one embodiment, the first sub-connector 142A may have a peripheral portion extending from a central portion. When the first sub-connector 142A has the receiving portion, the peripheral portion may be formed along the periphery of the receiving portion.

According to one embodiment, the venting path 131 may be formed on one surface of the case body, and may include one or more vertical and horizontal flow paths. As shown in FIGS. 4 and 5, the horizontal flow path may be opened and closed by the connector. Specifically, the horizontal flow path may be opened and closed by the peripheral portion of the connector. When the connector is in a normal state, the horizontal flow path may be closed. When the connector rises, the horizontal flow path may be opened to connect the inlet and the outlet of the venting path 131. Accordingly, when the internal pressure of the case body rises due to gas generated by the battery cell 200, the internal gas may be discharged to the outside.

In one embodiment, one or more battery cells may be disposed in the case body.

In one embodiment, a connection frame 210 for electrically connecting one or more battery cells may be provided, and the connection frame 210 may be electrically coupled to the connector 140.

Referring to FIGS. 4 and 5, the one or more battery cells 200 may be electrically connected to each other by the connection frame 210, and the second sub-connector 142B may be electrically connected to the connection frame 210.

The connection frame 210 may be an insulating frame which includes a conductive portion electrically connecting the one or more battery cells 200. By way of example, the connection frame 210 may be a busbar frame including a PCB board, a busbar, and the like, but the present disclosure is not limited thereto.

In one embodiment, a frame connector 220 may be disposed on the connection frame 210, and the second sub-connector 142B may be electrically connected to the frame connector 220. The frame connector 220 may be selectively used depending on the sizes and conditions of the battery cell 200, the main body 110, the first cover 130, the connector 140, and the like, and the size and shape of the frame connector 220 may be adjusted.

Referring to FIG. 5, when the first sub-connector 142A is raised in the outward direction, the first sub-connector 142A and the battery cell 200 may be electrically disconnected. In a normal operating state, the case body may remain sealed as shown in FIG. 4. However, when the internal pressure rises due to gas generated by the battery cell 200, the first sub-connector 142A may rise in the outward direction. As a result, the electrical connection between the first sub-connector 142A and the battery cell 200 may be broken.

Also, though not shown, in one embodiment, the battery case may not include a sub-connector. One surface of the main connector 141 may be electrically connected to an external device and the other surface thereof may be electrically connected to a battery cell. When the internal pressure increases, the main connector may rise and disconnect electrically from the battery cell.

Alternatively, the battery case may include one main connector and one sub-connector, and one surface of the sub-connector may be connected to the main connector and the other surface thereof may be connected to a battery cell. When the internal pressure increases, the sub-connector may rise and disconnect electrically from the battery cell. For example, the connector 140 may include the main connector 141 electrically connected to an external device and the first sub-connector 142A disposed at a lower portion of the main connector and electrically connected to the battery cell 200. That is, the connector 140 may not include the second sub-connector 142B. Thus, when the internal pressure of the case body rises, the first sub-connector 142A may be raised by the internal pressure, and the electrical connection between the first sub-connector 142A and the battery cell 200 may be released. Accordingly, the electrical connection between the main connector 141, which is electrically connected to the external device, and the battery cell 200 may be released, and the flow of current may be blocked.

However, the present disclosure is not limited thereto, and the numbers of main connectors and sub-connectors may be varied as appropriate.

In one embodiment, the connector 141, 142A, or 142B may include an insulating portion and a conductive portion.

Without being limited thereto, the insulating portion may include an insulating material, for example, ABS resin, polyalkylene terephthalate resin, polycarbonate resin, polypropylene resin, polyphthalamide resin, epoxy resin, amino resin, phenol resin, polyester resin, polyurethane resin, or the like. Furthermore, the insulating portion may have a weight sufficient to be movable in response to an increase in internal pressure of the battery case. In one embodiment, the conductive portion may include a material having conductivity, and may include a metal such as, but not limited to, copper, aluminum, and the like.

In one embodiment, the conductive portion may be a conductive terminal pin 143. The conductive terminal pin 143 may rise in the outward direction in response to an increase in internal pressure of the case body, thereby electrically disconnecting the conductive terminal pin 143 from the battery cell.

One end of the conductive terminal pin 143 may be electrically connected to an external device, and the other end thereof may be electrically connected to the battery cell 200 accommodated within the case body. In one embodiment, the conductive terminal pin 143 may be formed through the connector 140.

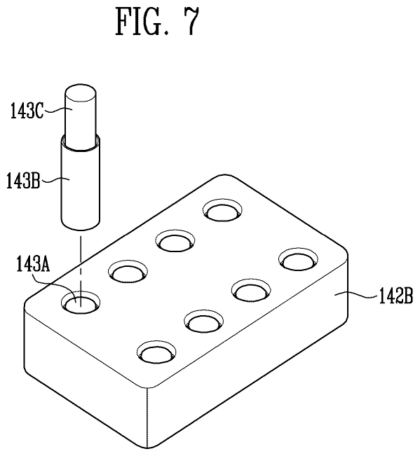

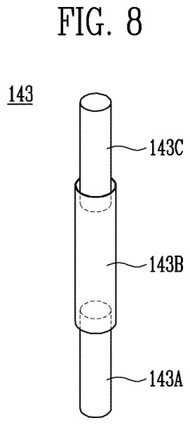

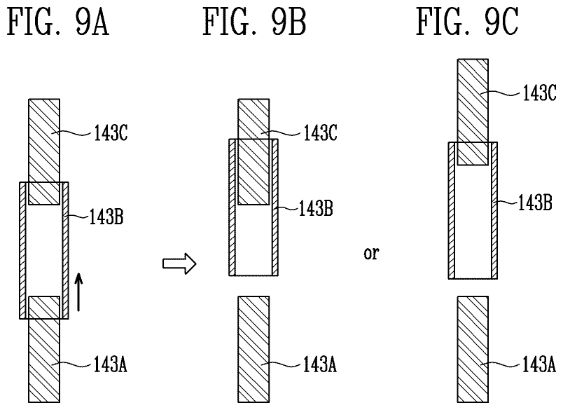

FIG. 7 is a diagram illustrating a structure in which the conductive terminal pin 143 is formed on the connector 140 according to one embodiment. FIG. 8 is a perspective view schematically illustrating the conductive terminal pin 143 according to one embodiment, and FIG. 9 is a diagram schematically illustrating a process by which the conductive terminal pin 143 is disconnected according to one embodiment.

Referring to FIGS. 8 and 9, the conductive terminal pin 143 according to one embodiment may have a detachable structure.

In one embodiment, the conductive terminal pin 143 includes a barrel portion 143B having a hollow portion, and a plunger 143C or a contact pin 143A having a portion inserted into the barrel portion 143B. When the internal pressure of the case body rises, the plunger 143C or the contact pin 143A may be inserted into the barrel portion 143B, thereby electrically disconnecting the conductive terminal pin 143 from the battery cell 200. That is, one end of the conductive terminal pin 143 is electrically connected to an external device, and the other end thereof is electrically connected to the battery cell 200 received inside the case body. The overall length of the conductive terminal pin 143 may be reduced to electrically disconnect the conductive terminal pin 143 and the battery cell 200 from each other. Alternatively, the entirety of the conductive terminal pin 143 may be raised in the outward direction and the electrical connection to the battery cell 200 may be released.

Specifically, in one embodiment, the conductive terminal pin 143 may include the contact pin 143A, the barrel portion 143B into which the contact pin 143A is inserted, and the plunger 143C inserted into the barrel portion. Further, in one embodiment, the conductive terminal pin 143 may include two parts, for example, the contact pin 143A and the barrel portion 143B, or the barrel portion 143B and the plunger 143C.

As shown in FIGS. 4 and 9A, a portion of the contact pin 143A is inserted at one end of the barrel portion 143B, and a portion of the plunger 143C is inserted at the other end of the barrel portion 143B, so that the respective parts of the conductive terminal pin 143 may be connected in a single body. Accordingly, the contact pin 143A may contact the frame connector 220 and be electrically connected to the battery cell 200, and the plunger 143C may be electrically connected to the external device to allow the battery cell 200 to be electrically connected to the external device.

In one embodiment, when the conductive terminal pin 143 includes the contact pin 143A and the barrel portion 143B, the barrel portion 143B may be exposed and electrically connected to an external device. Further, when the conductive terminal pin 143 includes the barrel portion 143B and the plunger 143C, the barrel portion 143B may be in contact with the frame connector 220.

In one embodiment, as shown in FIG. 9B or FIG. 9C, when the barrel portion 143B is moved in an upward direction, the barrel portion 143B may be disengaged from the contact pin 143A which is inserted at one end of the barrel portion 143B. As shown in FIG. 9B, only the barrel portion 143B may be moved, and the plunger 143C may not be moved. As a result, a larger portion of the plunger 143C may be inserted into the barrel portion 143B.

Alternatively, as shown in FIG. 9C, when the barrel portion 143B is moved in the upward direction, the barrel portion 143B and the plunger 143C may move together in the upward direction.

Accordingly, the contact pin 143A and the barrel portion 143B may be separated from each other to electrically disconnect the battery cell 200 from the external device.

Referring to FIG. 5, the contact pin 143A contacts the frame connector 220 and is electrically connected to the battery cell 200, and the contact pin 143A and the barrel portion 143B may be separated from each other to electrically disconnect the battery cell 200 from the external device. The plunger 143C may not rise, or may rise to the outside along with the barrel 143B.

In one embodiment, when the conductive terminal pin 143 is a two-stage separation structure including the contact pin 143A and the barrel portion 143B, the barrel portion 143B may rise in the upward direction and may be separated from the contact pin 143A when the internal pressure increases.

Alternatively, when the conductive terminal pin 143 is a two-stage separation structure including the barrel portion 143B and the plunger 143C, the barrel portion 143B may contact the frame connector 220 and the plunger 143C may move in the upward direction to be separated from the barrel portion 143B when the internal pressure rises.

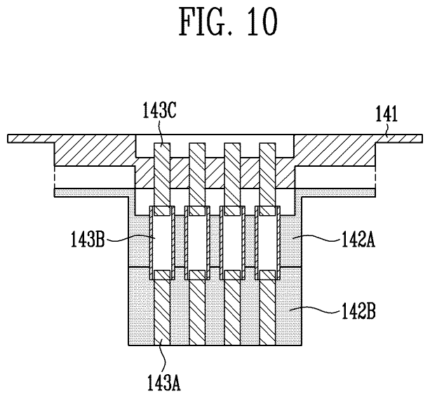

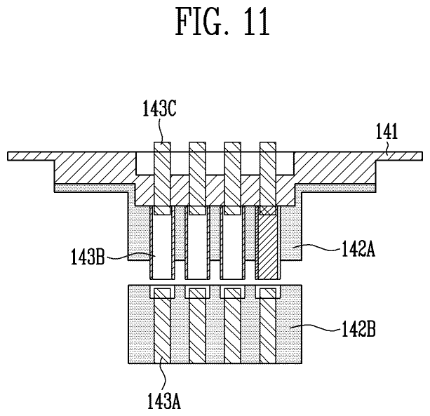

FIGS. 10 and 11 are diagrams illustrating the operation of the connector 140 and the conductive terminal pin 143 according to one embodiment of the present disclosure.

In one embodiment, one or more through-holes may be formed in the connector 140, and the conductive terminal pin 143 may be movably inserted into the through-holes.

In one embodiment, the plunger 143C of the conductive terminal pin 143 may be formed on the main connector 141, the barrel portion 143B of the conductive terminal pin 143 may be formed on the first sub-connector 142A, and the contact pin 143A of the conductive terminal pin 143 may be formed on the second sub-connector 142B.

As shown in FIGS. 4 and 10, in a normal operating state, the case body may remain sealed, and the battery cell 200 may be electrically connected to an external device by the connector 140 and the conductive terminal pin 143.

However, as shown in FIGS. 5 and 11, when the internal pressure rises due to gas generated by the battery cell 200 in the case body, the first sub-connector 142A may rise due to the internal pressure. The barrel portion 143B of the conductive terminal pin 143 may rise together. In addition, the plunger 143C of the conductive terminal pin 143 may be separated from the main connector 141 and move upwardly. The second sub-connector 142B and the contact pin 143A of the conductive terminal pin may be in contact with the frame connector 220. Alternatively, as shown in FIG. 9B, the plunger 143C of the conductive terminal pin 143 may not move, and only the barrel portion 143B may rise.

In one embodiment, when the conductive terminal pin 143 has a two-stage separation structure including the barrel portion 143B and the plunger 143C, the first sub-connector 142A and the barrel portion 143B may be in contact with the frame connector 220 without including the second sub-connector. When the internal pressure increases, the first sub-connector 142A and the barrel portion 143B may move in the upward direction to release the electrical connection between the conductive terminal pin 143 and the frame connector 220.

Alternatively, when the conductive terminal pin 143 has a two-stage separation structure including the contact pin 143A and the barrel portion 143B, the barrel portion 143B may be exposed through the main connector 141 and electrically connected to an external device. When the internal pressure rises, the second sub-connector 142B and the contact pin 143A of the conductive terminal pin are in contact with the frame connector 220, but the first sub-connector 142A and the barrel portion 143B may be moved in the upward direction to release the electrical connection between the conductive terminal pin 143 and the frame connector 220.

However, the present disclosure is not limited thereto, and various modifications are possible in accordance with the principles described above.

According to one embodiment of the present disclosure, the battery assembly may be a battery module. The battery module may include a case body having a receiving space therein; a battery cell disposed in the receiving space; and a connector formed on one surface of the case body and electrically connecting the battery cell to an external device. The connector may configured to be electrically disconnect from the battery cell when the internal pressure of the case body increases. The configuration and features of the case body and the connector are as described above.

One embodiment of the present disclosure may be a battery pack including one or more battery modules. The configuration and features of the battery modules are as described above. In addition to the battery modules, the battery pack may further include a pack case receiving the battery modules and various devices for controlling the charging and discharging of the battery modules, such as a battery management system (BMS), a current sensor, a fuse, and the like.

According to one embodiment of the present disclosure, a battery assembly with improved reliability may be provided.

According to one embodiment of the present disclosure, a battery assembly may prevent the spread of a fire by releasing electrical connection of a battery cell in the event of a fire.

According to one embodiment of the present disclosure, a battery assembly may reduce damage caused by the fire by discharging internal gases in the event of a fire.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery case, comprising:
a case body including a receiving space in which a battery cell is arranged; and
a connector formed on one surface of the case body and electrically connecting the battery cell arranged therein to an external device,
wherein the connector is configured to be electrically disconnected from the battery cell when the internal pressure of the case body increases.

2. The battery case according to claim 1, wherein the connector is moved in an outward direction to be electrically disconnected from the battery cell arranged therein when the internal pressure of the case body increases.

3. The battery case according to claim 1, further comprising a venting path formed in the case body, discharging gases generated in the case body to an outside, and opened and closed by the connector.

4. The battery case according to claim 3, wherein the venting path comprises vertical and horizontal flow paths, and the horizontal flow path is opened and closed by the connector.

5. The battery case according to claim 1, wherein the connector comprises:
a main connector electrically connected to an external device; and
one or more sub-connectors connecting the main connector to the battery cell arranged therein.

6. The battery case according to claim 5, wherein the main connector or one sub-connector of the one or more sub-connectors is moved in an outward direction to be electrically disconnected from the battery cell arranged therein when the internal pressure of the case body increases.

7. The battery case according to claim 1, wherein the connector comprises: a main connector electrically connected to an external device; a first sub-connector arranged at a lower portion of the main connector; and a second sub-connector arranged at a lower portion of the first sub-connector and electrically connected to the battery cell arranged therein, wherein the first sub-connector is moved in an outward direction to be electrically disconnected from the battery cell when the internal pressure of the case body increases.

8. The battery case according to claim 6, wherein the main connector and the one sub-connector are formed at a predetermined distance.

9. The battery case according to claim 1, wherein the connector comprises an insulating portion and a conductive portion and the conductive portion is a conductive terminal pin.

10. The battery case according to claim 1, wherein the connector comprises a conductive terminal pin, and the conductive terminal pin rises in the outward direction to electrically disconnect the conductive terminal pin from the battery cell as the internal pressure of the case body increases.

11. The battery case according to claim 1, wherein the connector comprises: a conductive terminal pin, wherein one end of the conductive terminal pin is connected to an external device and an other end thereof is electrically connected to the battery cell arranged therein, the conductive terminal pin including a barrel portion including a hollow portion; and a plunger or a contact pin whose portion is inserted into the barrel portion, and wherein the plunger or the contact pin is inserted into the barrel portion to electrically disconnect the conductive terminal pin from the battery cell when the internal pressure of the case body increases.

12. The battery case according to claim 7, wherein a plunger of a conductive terminal pin is formed on the main connector, a barrel portion of the conductive terminal pin is formed on the first sub-connector, and a contact pin of a conductive terminal pin is formed on the second sub-connector.

13. A battery assembly, comprising:
a case body including a receiving space therein;
one or more battery cells arranged in the receiving space; and
a connector formed on one surface of the case body and electrically connecting the one or more battery cells and an external device,
wherein the connector is configured to be electrically disconnected from the one or more battery cells when the internal pressure of the case body increases.

14. The battery assembly according to claim 13, further comprising a connection frame electrically connecting the one or more battery cells, wherein the connection frame is electrically connected to the connector.

15. The battery assembly according to claim 13, wherein the battery assembly is a battery module.

16. A battery pack comprising at least one battery module according to claim 15.
